(19) United States
(12) Patent Application Publication
(10) Pub. No.: US 2008/0126867 A1
(43) Pub. Date: May 29, 2008

(54) METHOD AND SYSTEM FOR SELECTIVE REGRESSION TESTING

(76) Inventors: Vinod Pandarinathan, Chennai (IN); Robert Sargent, Knoxville, TN (US); Richard Brian Livingston, Doral, FL (US); James Kevin Lambert, Pleasanton, CA (US); Michael W. Turnlund, Morgan Hill, CA (US); Donald Arthur Williams, San Ramon, CA (US); Balachander Chandrasekaran, San Ramon, CA (US); Lakshmankumar Mukkavilli, Sunnyvale, CA (US)

Correspondence Address: SCHWEGMAN, LUNDBERG & WOESSNER, P.A., P.O. BOX 2938, MINNEAPOLIS, MN, 55402, US

(21) Appl. No.: 11/468,730

(22) Filed: Aug. 30, 2006

(51) Int. Cl. G06F 11/28

(52) U.S. Cl. 714/37; 714/E11.178

(57) ABSTRACT

A system and method for selective regression testing is described. The system and method provides a test script database identifying multiple portions of a first low level code (e.g., assembly code) and tests associated with at least one of the multiple portions of first low level code. A comparator may identify a change set between the multiple portions of the first low level code and corresponding portions of modified low level code. After the database has been queried by a changed set query module, using the identified change set as key, an optimum or reduced test suite is identified from the database, to be run on the modified low level code, thereby to verify the change set.

### TECHNICAL FIELD

The present application relates, in general, to the field of computer systems. More specifically, the present application relates to a method and system for selective regression testing or changed based testing of computer software to obtain an appropriate test suite for verifying modifications made to computer software.

### BACKGROUND

Computer programs, such as those written in C and C++, often undergo several modification, development and improvement efforts. These development efforts may involve the modification of a program to improve its functionality and reduction or elimination of redundant variables and/or functions. Some of these development activities may involve the addition or removal of symbols and functions and the redefinition of factors. These development activities may or may not lead to functional changes in the compiled source code file and or header files of a program. Development activities that do not bring about any functional change in the compiled code may include removal of dead codes, restructuring header files, movement of functions from one file to another and creating self-compilable header files.

Various software applications or tests are available for verifying changes or modifications in software. Examples of such tests are sanity tests, which verify the complete integrity of an image, component tests and feature tests. An image is a software unit that may, for example, be loaded on a router, which uses one unit per router.

Different tests, as mentioned above, would typically be run on computer software to test different functionality in a system or apparatus, especially once changes or modifications have been made to the software.

For example, basic functionality tests may be run, performance tests may be run to determine how many active routes a router may be able to handle at a given time and a memory test may be run and tests may be run for IC routing. Tests may also be run for EIGPR protocol which configures EIGPR. Further examples of tests which may be run is tests where a line is disconnected, either manually or by disconnecting the line through software, thereby to determine the time period in which the EIGRP routing protocol would reroute data. It is typically the functionality of the EIGRP to detect when a network is unavailable and to reroute data in order for the data to reroute to a destination Internet Protocol (IP) address through another interface. This is called convergence and may be tested through a convergence test. An IBM test may also be run to test the IBM code forming part of an application, for example, protocol conversation may be tested.

One methodology used in running tests is to compare two different versions of a compiled software program to determine whether changes in the high level language, such as C or C++, has occurred in the low level, assembly or source code language. Comparison tools exist to compare a source code and its versions to determine differences between them. A comparison tool typically enables automation of source code modularity, dead code removal and other aspects of source re-writing. Conventionally, comparison testing is performed by comparing the binary equivalents of the source code and its versions.

Selective retesting, in particular, is used to retest a software program that has been modified to ensure that any problems in the code, or bugs, have been resolved and that newly added features to the software have not created problems with previous versions of the software. Selective retesting, or verification testing, is initiated by a programmer, after the programmer has attempted to resolve a recognized problem or has added source code to a program that may have inadvertently introduced errors. It is typically a quality control measure to ensure that the newly modified code still complies with its specified requirements and that unmodified code has not been affected by the maintenance activity.

A problem that has been identified with running these tests is that a programmer or tester has to determine the exact test suite, comprising various test scripts, that needs to run on the change or modification set to verify the new or changed functionality of the computer software. With current tests, it remains a probability for the change set to introduce functional failure when the test suites running against the software of change set did not exercise the change set.

A further problem that has been identified with conventional methods of testing is that minimal test suite is not identified to verify the change set. Such a minimal test suite would avoid running tests where there is no intersection with the changes made to the software. This feature is especially necessary, as running tests may be time consuming, ineffective and expensive.

### BRIEF DESCRIPTION OF THE DRAWINGS

Embodiments are illustrated by way of example and not limitation in the figures of the accompanying drawings, in which like references indicate similar elements and in which:

FIG. 1 is a schematic diagram illustrating a block diagram of a system for selective regression testing in accordance with an example embodiment;

FIG. 2 is a schematic diagram illustrating the building of a database by a code coverage module and database builder, from source code and various test scripts, in accordance with an example embodiment;

FIG. 3 is a schematic diagram illustrating a comparator identifying changes and differences between first source code and modified source code in accordance with an example embodiment;

FIG. 4 is a schematic diagram illustrating the flow of the operations performed by the system as shown in FIG. 1;

FIG. 5 shows a high-level flow diagram illustrating a method of selective regression testing in accordance with an example embodiment;

FIG. 6 shows a detailed flow diagram illustrating a method of selective regression testing in accordance with an example embodiment; and

FIG. 7 is a block diagram showing a machine for performing any one of the example methods described herein.

### DETAILED DESCRIPTION

The present application relates to method and system for selective regression testing (SRT), also known as changed based testing or delta based testing (DBT).

The selective regression testing system and method in accordance with the example embodiment may be aimed at determining and identifying a test suite that verifies the functional failures in modified computer software or software code. The SRT system and method may further, in response to identifying an optimal test suite (or at least reduced test suite), initiate the appropriate test scripts to verify the modified code.

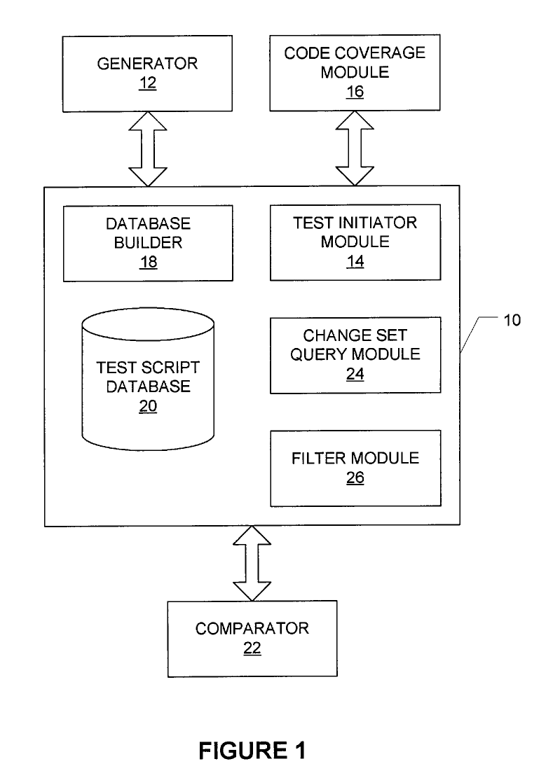

FIG. 1 shows a schematic block diagram of a selective regression testing system 10 in accordance with an example embodiment. The system 10 may either include all functional modules to conduct selective regression testing, or may alternatively communicate with certain modules that will provide the system 10 with additional functionality, thereby to enable the system 10 to conduct selective regression testing on computer software. For example, the system 10 may communicate or may include a generator 12 to generate multiple portions of low level code (herein described by way of example with reference to assembly code) from a high level computer language and a code coverage module 16 to provide various modules of the system 10 with an analysis of computer codes' performance, and in particular with an analysis of an association between an assembly code (for example, compiled, source or machine code) in combination with test scripts exercised on the software. The system 10 may also communicate or may include a comparator 22 to identify the difference, or change set, between first or original assembly code and second or modified assembly code. As mentioned above, embodiments are described merely by way of example with reference to assembly code and could apply equally to object or any other low level code that is derived from a higher level code.

As mentioned, the generator 12 may generates assembly codes corresponding to original or modified high level computer language code, such as C or C++. The assembly code for any high level computer language can be obtained by specifying an appropriate command line option to a compiler. The generated assembly codes, for example first assembly codes corresponding to first high level code and modified assembly code corresponding to modified high level code may be used by the code coverage module 16 to analyze the association between the assembly code and executed test scripts. The generated assembly codes may further be used by the comparator 22 to identify the change set between versions of the original source code.

The selective regression testing system 10 may further include a test initiator module 14, which initiates, optionally in combination with code coverage module 16, a test suite comprising various test scripts on the assembly code. Software development companies may have multiple test suites, comprising test scripts, to be executed on software thereby to test the software. The test initiator module 14 may verify that a computer program works as expected. When used with the code coverage module 16, the test initiator module 14 may assist the code coverage module 16 to analyze the source codes' performance.

An example of a code coverage module 16 is a profiling tool such as GCOV. GCOV provides a programmer or user with performance statistics such as how often each line of assembly code is executed, what lines of source code are actually executed, and the computing time (or runtime duration) each section of code uses. The code coverage tool GCOV can only be executed on compiled code, in particular source code or assembly code that has been compiled by GNU Compiler Collection (GCC).

When the code coverage module 16 is used with the test initiator module 14, a programmer can further determine how much of the computer program is exercised by a particular test suite and the different types of test scripts required for sufficient testing of the computer program. The code coverage module 16 identifies the pieces of code which are exercised by each test suite or test script.

A database builder 18 also forms part of the selective regression testing system 10. The database builder 18 receives data from the code coverage module 16 to populate a test script database 20 of the system 10. It will be appreciated that the database builder 18 may, in certain circumstances be a subsystem of the code coverage module 16 and that the data may be a direct output of the code coverage module 16.

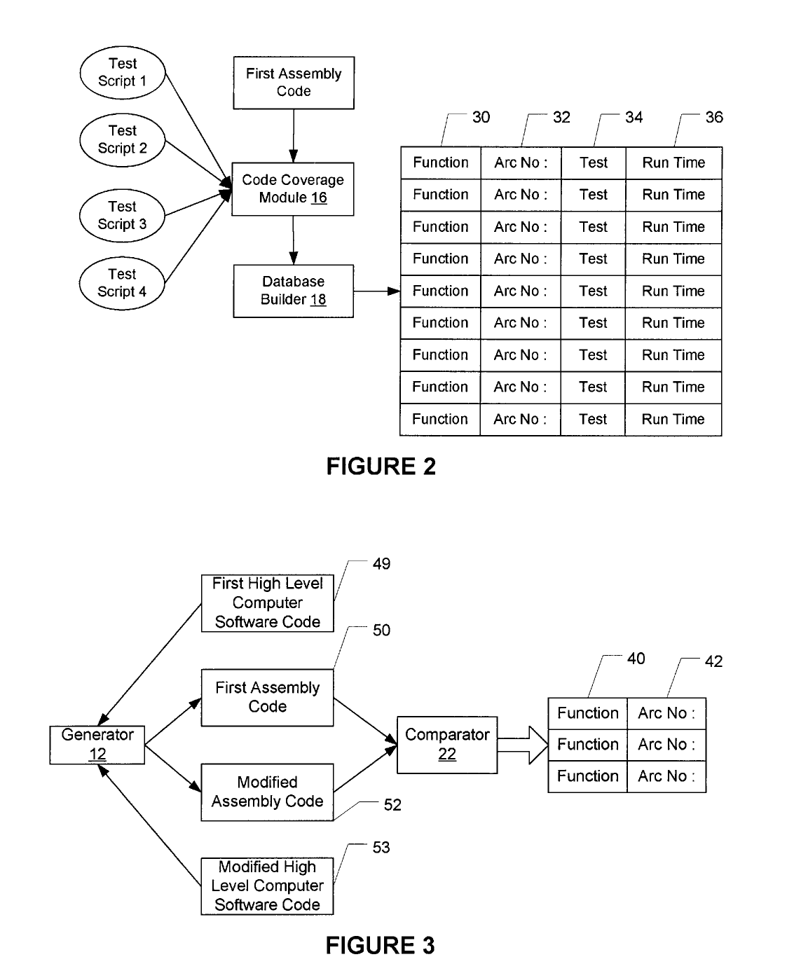

The data stored in the test script database 20 may include the test suite path and the basic blocks of the source or assembly code which the test suite and test scripts exercised. For example, as shown in FIG. 2, the basic blocks of source or assembly code, also defined as portions of the assembly code, may include an identifier, such as a name, for the source code function 30 and an arc number 32. A function is split into multiple portions of assembly code, also called arcs. An arc is a group of instructions that does not alter the instruction sequence of a computer program. Another explanation of an arc is a collection of inspections or a linear sequence of instructions that does not have any branch instructions. Each arc is labeled and stored in the test script database 20.

Together with the function identifier 30 and arc number 32, the relevant test script 34 that is associated with the arc and the runtime duration 36 of the test script on the relevant arc may also be stored in the test script database 20. All this information is stored in the form of key-value pairs, as shown in FIG. 2.

As mentioned, the comparator 22 identifies a change set between versions of the original source or assembly code. For example, the comparator 22 may compare, by using object code comparison, the first or original assembly code 50 generated by the generator 12 from the first high level program 49 with the modified assembly code 52, also generated by the generator 12 from the modified high level program 53 and may identify the code that is functionally equivalent. As shown in FIG. 3, the change set includes the function identifier 40 and arc number 42 of the assembly code that differs between the two versions of code.

The selective regression testing system 10 may further include a change set query module 24 that queries the test script database 20 with the change set as the query key. The key used to query the database 20 will accordingly be the output of the comparator 22 and is both the function identifier 40 or function name and the arc number 42. The appropriate test script and the runtime of the test script, which are associated with the change set, is obtained by the change set query module 24 and forms a minimum and optimum test suite or at least reduced test suite.

The data retrieved by the query contains all the information required to run the script and the time taken for the test script to complete. The appropriate test script to verify the change set is identified from the database.

When more than one test script is detected for the change set, a filtering module 26, forming part of the system 10, may apply a filtering process to eliminate multiple test scripts associated with a particular portion of code or arc. The filtering module 26 aims to efficiently determine which subset of test scripts are the most appropriate to run on the change set, thereby to verify the change set. For example, as the runtime duration identifies the test suite or test script that verifies the change set in a minimal time, the filtering module 26 may select a test suite or test script with the shortest runtime duration for the particular arc.

Once the minimum and optimum test suite has been identified, the test initiator module 14 initiates and executes the test suite to verify the change set.

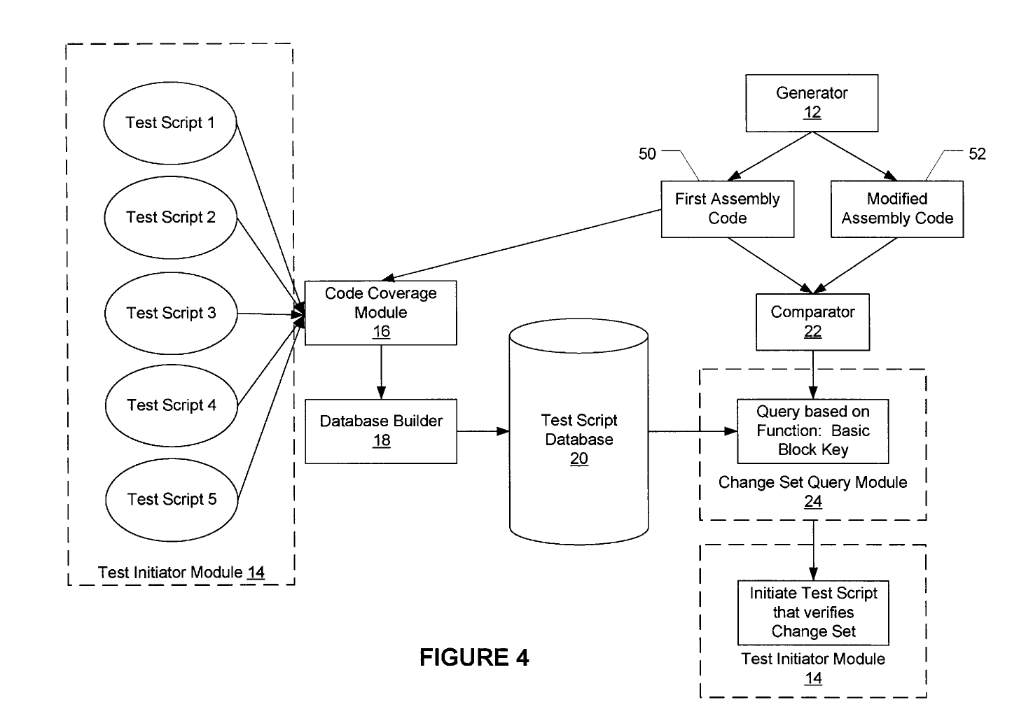

FIG. 4 shows an example flow of the operations performed by the selective regression testing system 10. The test initiator module 14 may execute tests or test scripts on the first assembly code, after the first assembly code 50 is generated from the first high level code 49 by the generator 12. The code coverage module 16 is used, with the test initiator module 14 to identify the portions of first assembly code (or arcs) 50 which are exercised by each test script. The database builder 18, as also shown in FIG. 2, now populates the test script database 20.

The generator 12 also generates the modified assembly code 52 from the modified high level code 53 by assembling the high level code. The comparator 22 compares the first assembly code 50 to the modified assembly code 52 and identifies a change set between the versions of the assembly code. As shown in FIG. 3, the change set may include a function identifier 40 and arc number 42 and the change set may be used as an input by the change set query module 24 to query the test script database 20. The appropriate test script and the runtime duration of the test script, which are associated with the change set, are obtained by the change set query module 24 and forms a minimum, optimum test suite or reduced test suite. The test initiator module 14 may now initiate the optimum test suite to verify the change set of the versions of software.

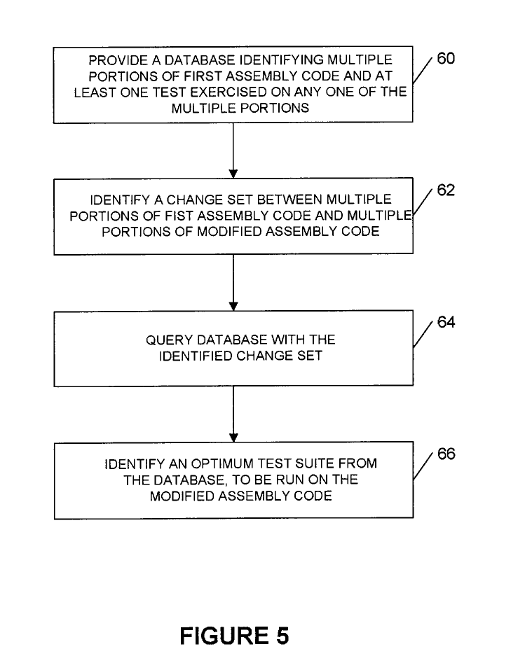

Turning to FIG. 5, the method of selective regression testing is described in accordance with an example embodiment.

Starting at operation 60, the method comprises providing a test script database 20 identifying multiple portions of a first assembly code and tests exercised on any one of the multiple portions of first assembly code. The comparator 16, in operation 62, identifies a change set between the multiple portions of the first assembly code and multiple portions of modified assembly code, which have been generated by the generator. The change set query module 24 queries the test script database 20 with the change set (operation 64) and the test initiator module 14 identifies, in operation 66, a minimum, optimum or preferred test suite from the database 20 to be run on the modified assembly code. This will verify the change set between the first assembly code and the modified assembly code.

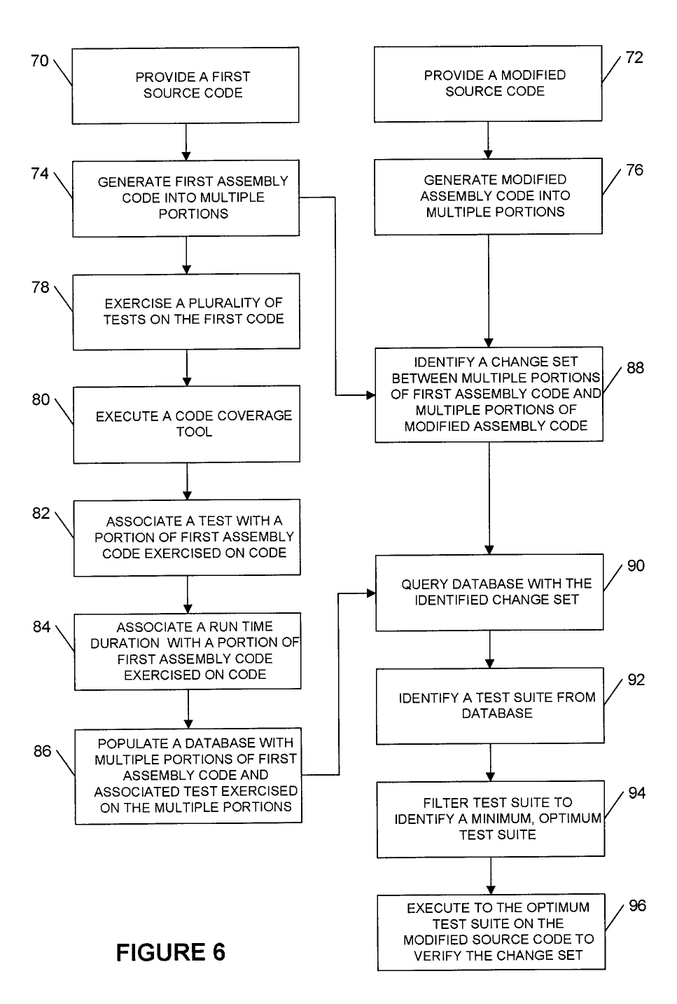

A detailed flow diagram of the example method's operations is illustrated in FIG. 6 and starts with operations 70 and 72 where a first (or original) high level code and modified (or second) high level code are provided. The generator 12 generates, by compiling the different versions of high level code, first (or original) assembly code and modified (or second) assembly code respectively in operations 74 and 76.

In operation 78 a plurality of tests or test scripts, forming part of an extended test suite, are exercised on the first assembly code. A code coverage tool or code coverage module 16 such as GCOV is executed in operation 80 and is used to associate a plurality of tests with portions or arcs of the first assembly code in operation 82. This association will be made whenever the portion of assembly code or arc is exercised by one of the plurality of test scripts. Similarly, in operation 84, a runtime duration is also associated with a portion of first assembly code on which a test script has been exercised. This runtime duration may be used for filtering the associated test scripts and for determining an optimum, minimum test suite or preferred test suite to verify the change set.

In operation 86, the database builder 18 populates the test script database 20 with the multiple portions of first assembly code, which may include the function identifier and arc number, as well as the relevant test, and the runtime duration.

As described in accordance with FIG. 5, the comparator 16, in operation 88, identifies a change set between the multiple portions of the first assembly code and the multiple portions of modified assembly code, which have been generated by the generator 12. In operation 90, the change set query module 24 queries the test script database 20 with the change set. The test initiator module 14 identifies a test suite from the database 20 to be run on the modified source code (shown in operation 92).

In operation 94, the filtering module filters the test scripts associated with the portions of code, for example by identifying a test script with a minimum runtime duration. An optimum, minimum test suite is thereby identified, which will verify the change set between the first source code and the modified source code in an optimum manner. The test initiator module 14, executes the optimum test suite on the modified source code, in operation 96, thereby to verify the change set.

By verifying the change set, the programmer or tester can confirm that the modified high level code is working properly and has not imported further problems or bugs in the software. Also, by exercising the example embodiment, a programmer can identify only the tests necessary to verify or test the changes made to the software. This may ultimately result in reducing the cost of black-box testing, increasing the effectiveness of automated testing, reducing the time to market of the product, reducing customer escapes and lowering operational costs.

The system identifies the test script that tests the change set and runs the fastest. Thus, the system may ensure the time taken and the number of machine cycles required for the verification of a change set is minimal.

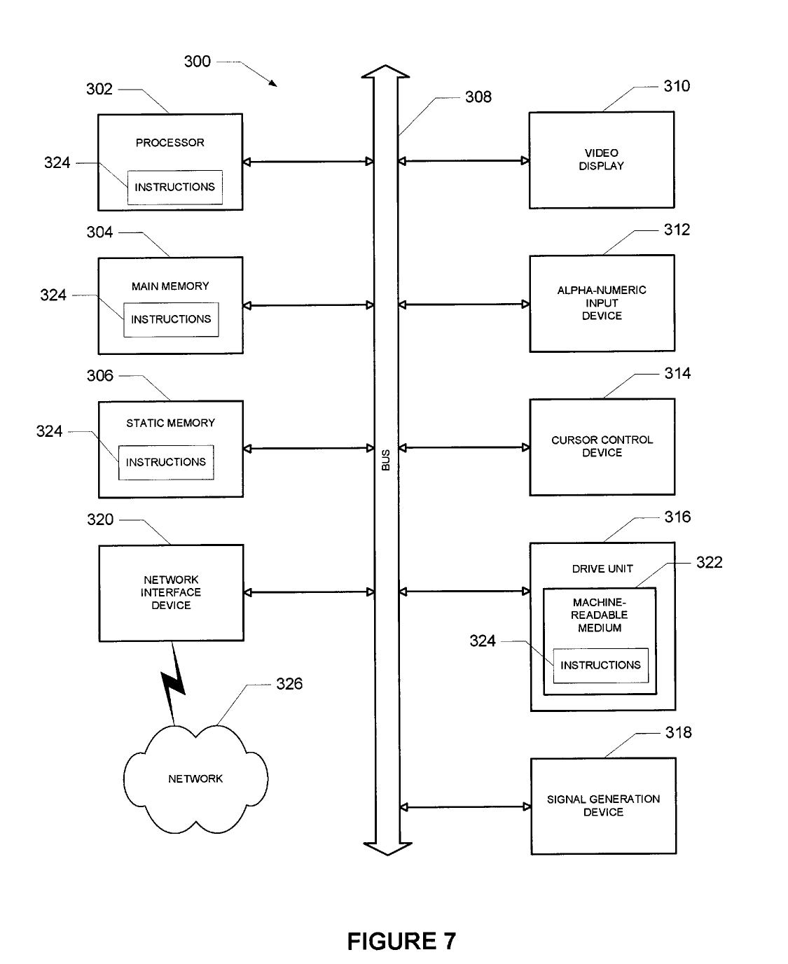

FIG. 7 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions and data structures (e.g., software 324) embodying or utilized by any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320 utilizing any one of a number of well-known transfer protocols (e.g., HTTP).

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method of selective regression testing, the method comprising:
providing a database identifying multiple portions of a first low level code and a plurality of tests associated with at least one of the multiple portions of first low level code;
identifying a change set between the multiple portions of the first low level code and multiple portions of modified low level code;
querying the database with the change set; and
identifying a test suite from the plurality of tests to be run on the change set.

2. The method of claim 1, wherein the providing the database comprises:
exercising the plurality of tests on the first low level code; and
associating at least one of the plurality of tests with a portion of the first low level code whenever the portion is exercised by the one of plurality of tests.

3. The method of claim 1, wherein the first low level code and the modified code is assembly code or object code.

4. The method of claim 1, wherein the providing multiple portions of the first low level code comprises:
providing a first high level computer source code; and
generating the multiple portions of the first low level code from the first high level computer source code.

5. The method of claim 1 wherein the identifying a change set comprises comparing multiple portions of modified low level code with corresponding portions of the first low level code.

6. The method of claim 5, wherein the providing the multiple portions of the modified low level code comprises:
providing a modified high level computer source code; and
generating the multiple portions of modified low level code from the modified high level source code.

7. The method of claim 1, which comprises:
associating a runtime duration with one of the plurality of tests with a portion of the first low level code when the portion is exercised by the one of plurality of tests; and
selecting a test suite based on the shortest runtime duration.

8. The method of claim 1, which comprises:
identifying a reduced test suite from the database to be run on the modified low level code by filtering the plurality of tests based on the change set.

9. The method of claim 1, which comprises:
executing a code coverage tool to identify the change set by comparing the multiple portions of the first low level code and the multiple portions of the modified low level code.

10. The method of claim 1, which comprises executing the test suite on the modified low level code to verify the change set, and tests in the plurality of tests that do not execute on the change set are excluded from the tests suite.

11. The method of claim 1, wherein the portions of low level code are arcs.

12. Apparatus to perform selective regression testing, the apparatus comprising:
a database to identify multiple portions of a first low level code and a plurality of tests associated with at least one of the multiple portions of the first low level code; and
change set query module to:
identify a change set between the multiple portions of first low level code and multiple portions of modified low level code;
querying the database with the change set; and
identifying a test suite from the plurality of tests to be run on the change set.

13. The apparatus of claim 12, wherein the first low level code and modified low level code is assembly code or object code.

14. The apparatus of claim 12, wherein the test suite is configured to execute on the modified low level code to verify the change set, and the apparatus being configured so that tests in the plurality of tests that do not execute on the change set are excluded from the test suite.

15. A system to perform selective regression testing, the system comprising:
test initiator module to:
execute a plurality of tests on a first low level code;
a database builder to:
receive, from a code coverage module, information on an association between a plurality of tests and a portion of the first low level code whenever the portion is exercised by the one of the plurality of tests; and
populate a database that identifies the one of the plurality of tests which is associated with the multiple portions of the first low level code;
a change set query module to:
receive, from a comparator, information on a change set between the multiple portions of first low level code and multiple portions of modified low level code; and
query the database with the change set,
wherein the test initiator module further identifies a test suite from the database to be run on the modified low level code.

16. The system of claim 15, which comprises:
a generator to compile first high level source code into multiple portions of first low level code and modified high level source code into multiple portions of modified low level code.

17. The system of claim 15, which comprises:
a code coverage module to associate one of the plurality of tests with a portion of the first low level code whenever the portion is exercised by the one of plurality of tests.

18. The system of claim 15, which comprises:
a comparator to identify a change set from the multiple portions of first low level code and the multiple portions of modified low level code.

19. The system of claim 15, which comprises:
a filtering module to filter the plurality of tests associated with the change set, thereby to identify a reduced test suite to be run on the modified low level source code.

20. The system of claim 19, wherein the first low level code and modified low level code is assembly code or object code.

21. A machine-readable medium embodying instructions, which when executed by a machine, cause the machine to:
provide a database identifying multiple portions of a first low level code and a plurality of tests associated with at least one of the multiple portions of first low level code;
identify a change set between the multiple portions of the first low level code and multiple portions of modified low level code;
query the database with the change set; and
identify a test suite from the plurality of tests to be run on the change set.

22. A system for selective regression testing, the system comprising:
means for providing a database identifying multiple portions of a first low level code and a plurality of tests associated with at least one of the multiple portions of first low level code;
means for identifying a change set between the multiple portions of the first low level code and multiple portions of modified low level code;
means for querying the database with the change set; and
means for identifying a test suite from the plurality of tests to be run on the change set.
